(19) United States
(12) Patent Application Publication
(10) Pub. No.: US 2019/0391063 A1
(43) Pub. Date: Dec. 26, 2019

(54) PARTICULATE DETECTING ELEMENT AND PARTICULATE DETECTOR

(71) Applicant: NGK INSULATORS, LTD., Nagoya-City (JP)

(72) Inventors: Keiichi KANNO, Nagoya-City (JP); Kazuyuki MIZUNO, Nagoya-City (JP); Hidemasa OKUMURA, Nagoya-City (JP)

(73) Assignee: NGK INSULATORS, LTD., Nagoya-City (JP)

(21) Appl. No.: 16/560,253

(22) Filed: Sep. 4, 2019

Related U.S. Application Data
(63) Continuation of application No. PCT/JP2017/032101, filed on Sep. 6, 2017.

(30) Foreign Application Priority Data
Mar. 10, 2017 (JP) 2017-045632
Mar. 10, 2017 (JP) 2017-045633

(51) Int. Cl. G01N 15/06

(52) U.S. Cl. CPC G01N 15/0656; G01N 2015/0007; G01N 15/0606

(57) ABSTRACT

A particulate detecting element includes a casing having a gas flow channel that enables gas to pass therethrough, a charge generating unit configured to impart charges generated by electric discharge to the particulates in the gas introduced into the casing and turn the particulates into charged particulates, a collection electrode disposed in the casing, where the collection electrode collects a collection target representing one of the charged particulate and the charge not imparted to the particulate, and a deceleration electrode disposed such that at least part of the deceleration electrode is away from an outer wall of the gas flow channel in the casing, where the deceleration electrode generates a deceleration electric field that decelerates the collection target at least one of upstream of the collection electrode in a gas flow direction and above the collection electrode.

### BACKGROUND OF THE INVENTION

### 1. Field of the Invention

The present invention relates to a particulate detecting element and a particulate detector.

### 2. Description of the Related Art

Some existing particulate detectors impart electric charges to particulates in the gas to be measured introduced into a casing, collect the particulates each having the electric charge imparted thereto, and measure the number of particulates on the basis of the amount of charge of the collected particulates (for example, PTL 1). The particulate detectors measure the number of particulates on the basis of the amount of charge of the particulates collected by measurement electrodes.

### CITATION LIST

### Patent Literature

PTL 1: PCT Pamphlet WO 2015/146456

### SUMMARY OF THE INVENTION

To detect particulates on the basis of the collection target (for example, charged particulates) collected by the electrode, it is required for particulate detectors to more easily collect the collection target.

The present invention has been made to solve such a problem, and its main object is to make it easy to collect a collection target by using a collection electrode.

According to the present invention, to achieve the above-described main object, the techniques described below are employed.

According to the present invention, a particulate detecting element for detecting particulates in gas is provided. The particulate detecting element includes a casing having a gas flow channel that enables the gas to pass therethrough, a charge generating unit configured to impart charges generated by electric discharge to the particulates in the gas introduced into the casing and turn the particulates into charged particulates, a collection electrode disposed in the casing, where the collection electrode collects a collection target representing one of the charged particulate and the charge not imparted to the particulate, and a deceleration electrode disposed such that at least part of the deceleration electrode is away from an outer wall of the gas flow channel in the casing, where the deceleration electrode generates a deceleration electric field that decelerates the collection target at least one of upstream of the collection electrode in a gas flow direction and above the collection electrode.

According to the particulate detecting element, the charge generation portion generates electric charge to turn particulates in the gas into charged particulates, and the collection electrode collects the collection target (either charged particulates or charge not imparted to the particulates). Since the physical quantity changes according to the collection target collected by the collection electrode, the particulates in the gas can be detected by using the particulate detecting element. At this time, a deceleration electrode generates a deceleration electric field and decelerates the collection target on at least one of the upstream side of the collection electrode in the gas flow and above the collection electrode. In addition, at least part of the deceleration electrode is separated from the outer wall of the gas flow channel. That is, at least part of the deceleration electrode is positioned closer to the central axis of the gas flow channel, as compared with, for example, the case where the deceleration electrode is disposed along the inner peripheral surface of the outer wall of the gas flow channel. For this reason, the deceleration electric field is likely to act on a region near the central axis of the gas flow channel, which is a region where the flow velocity is relatively high. Thus, the collection target having a relatively high flow velocity can be decelerated by the deceleration electric field. The action of the deceleration electric field facilitates collection of the collection target by the collection electrode. As a result, the particulate detecting element according to the present invention can, for example, increase the collection efficiency of the collection target by the collection electrode and reduce the length of the collection electrode (the length in the axial direction of the gas flow channel) so that a compact casing is provided. The expression “decelerating the collection object” includes not only the meaning of “decelerating the collection object” but “pushing the collection object back upstream”. The expression “above the collection electrode” means “in a region located above the collection electrode in a direction perpendicular to the central axis of the gas flow channel”. The particulate detecting element according to the present invention may be used to detect the amount of particulates in the gas. The “amount of particulates” may be at least one of, for example, the number, the mass, and the surface area of particulates.

In the particulate detecting element according to the present invention, the casing may have a partition portion configured to partition off the gas flow channel into a plurality of branch flow channels, and the collection electrode may be disposed in each of the plurality of branch flow channels. In this manner, the presence of a collection electrode in each of the branch flow channels facilitates collection of the collection target by the collection electrodes.

In this case, the particulate detecting element according to the present invention may further include at least one electric field generating electrode configured to generate a collection electric field for moving the collection target toward the collection electrode disposed in at least one of the branch flow channels. In this manner, the particulate detecting element can move the collection target toward the collection electrode by the collection electric field in addition to decelerating the collection target by the deceleration electric field. As such, the particulate detecting element can more easily collect the collection target by the collection electrode.

In this case, the particulate detecting element according to the present invention may further include a plurality of pairs each consisting of the collection electrode and the electric field generating electrode, and each of the branch flow channels may have one of the pairs disposed therein. In this manner, the collection target can be more easily collected by the collection electrodes.

In the particulate detecting element according to the present invention having a form including at least one electric field generating electrode, at least one of the electric field generating electrodes may further function as the deceleration electrode. In this way, the device configuration can be made more compact than in the case where the electric field generating electrode and the deceleration electrode are provided separately. In this case, among the at least one electric field generating electrode, the electric field generating electrode disposed in the partition portion may further function as the deceleration electrode.

In the particulate detecting element according to the present invention, the casing may include a deceleration electrode arrangement member on which the deceleration electrode is to be disposed, and the deceleration electrode arrangement member may be disposed on the inner side of the outer wall. In this manner, the deceleration electrode can be supported by the deceleration electrode arrangement member. Note that if the deceleration electrode is disposed in the partition portion described above, the partition portion corresponds to the deceleration electrode arrangement member. In this case, since the partition portion further functions as the deceleration electrode arrangement member, the device configuration can be made more compact than in the case where the two are separately provided.

In the particulate detecting element according to the present invention having a form including the deceleration electrode arrangement member, a distance Lf, in a central axis direction of the gas flow channel, between an upstream end of the deceleration electrode arrangement member in the gas flow direction and the deceleration electrode may be less than or equal to a distance H, in a direction perpendicular to a central axis of the gas flow channel, between the deceleration electrode arrangement member and a wall portion of the casing. If the condition: Lf≤H is satisfied, the length in the axial direction of the deceleration electrode arrangement member located upstream of the deceleration electrode in the gas flow direction (=the distance Lf) is relatively small. As a result, the deceleration electrode arrangement member is less likely to prevent the deceleration of the collection target caused by the deceleration electric field.

In the particulate detecting element according to the present invention having a form including the deceleration electrode arrangement member, the deceleration electrode may be disposed on an upstream end surface of the deceleration electrode arrangement member in the gas flow direction. Since the upstream end surface of the deceleration electrode arrangement member is a surface facing the oncoming gas flow, the presence of the deceleration electrode on this surface increases the deceleration effect of the deceleration electric field generated by the deceleration electrode on the collection target. In this case, if the deceleration electrode is disposed on the upstream end surface of the deceleration electrode arrangement member, the above-described distance Lf has a value of 0 and, thus, the condition Lf≤H is satisfied.

In the particulate detecting element according to the present invention having a form including the deceleration electrode arrangement member, the deceleration electrode arrangement member may have, at the upstream end thereof in the gas flow direction, a decelerating structure having a shape with a cross-sectional area larger than that of the other portion as viewed in a cross section perpendicular to the central axis of the gas flow channel. In this manner, the decelerating structure having a large cross-sectional area at the upstream end thereof serves as a gas flow resistance. Consequently, the collection target can be decelerated by the decelerating structure. Therefore, the collection target can be further decelerated by both the deceleration electric field and the decelerating structure. In addition, the decelerating structure can disturb the flow of the gas, and a gas vortex can be generated downstream of the decelerating structure. This vortex can extend the retention time of the collection target passing around the collection electrode and, thus, collection of the collection target by the collection electrode is facilitated.

The particulate detecting element according to the present invention may include an electric field generating electrode for generating a collection electric field for moving the collection target toward the collection electrode. In this case, the electric field generating electrode may further function as a deceleration electrode. In this case, the electric field generating electrode which further functions as the deceleration electrode may be disposed in the above-described deceleration electrode arrangement member.

According to the present invention, a particulate detector includes the particulate detecting element having any one of the forms described above and a detection unit configured to detect the particulates on the basis of a physical quantity that changes in accordance with collection targets collected by the collection electrode. Therefore, the particulate detector has the same effect as the above-described particulate detecting element according to the present invention, such as an effect of facilitating collection of the collection target by the collection electrode. In this case, the detection unit may detect the amount of the particulates on the basis of the physical quantity. The “amount of particulates” may be, for example, at least one of the number, mass, and surface area of the particulates. In the particulate detector, if the collection target is the charge not imparted to the particulate, the detection unit may detect the particulate on the basis of the physical quantity and the charge generated by the charge generation unit (for example, the number of charges or the amount of charge).

In the present specification, the term “charge” refers to an ion in addition to positive charge or negative charge. The term “detecting the amount of particulates” further includes the term “determining whether the amount of particulates falls within a predetermined numerical range (for example, whether the amount of particulates exceeds a predetermined threshold). Any parameter that changes on the basis of the number of collection objects (the amount of charge) can be the “physical quantity”. An example of “physical quantity” is an electrical current.

### BRIEF DESCRIPTION OF THE DRAWINGS

FIG. 1 is a perspective view of the schematic configuration of a particulate detector 10.

FIG. 2 is a cross-sectional view taken along a line A-A of FIG. 1.

FIG. 3 is a partial cross-sectional view taken along a line B-B of FIG. 1.

FIG. 4 is an explanatory diagram of the state of an electric field generated by a deceleration electrode 70 and an acceleration electrode 80.

FIG. 5 is an explanatory diagram of distances Lf and Lr and a distance H.

FIG. 6 is an exploded perspective view of a particulate detecting element 11.

FIG. 7 is an explanatory diagram of deceleration electrodes 170a and 170b according to a modification.

FIG. 8 is an explanatory diagram of a deceleration electrode 270 according to a modification.

FIG. 9 is an explanatory diagram of a decelerating structure 273.

FIG. 10 is an explanatory diagram of a deceleration electrode 370 according to a modification.

FIG. 11 is an explanatory diagram of a deceleration electrode 470 according to a modification.

FIG. 12 is an explanatory diagram of a deceleration electrode 570 according to a modification.

FIG. 13 is an explanatory diagram of a deceleration electrode 670 according to a modification.

FIG. 14 is a cross-sectional view of a particulate detector 710 according to a modification.

### DETAILED DESCRIPTION OF THE INVENTION

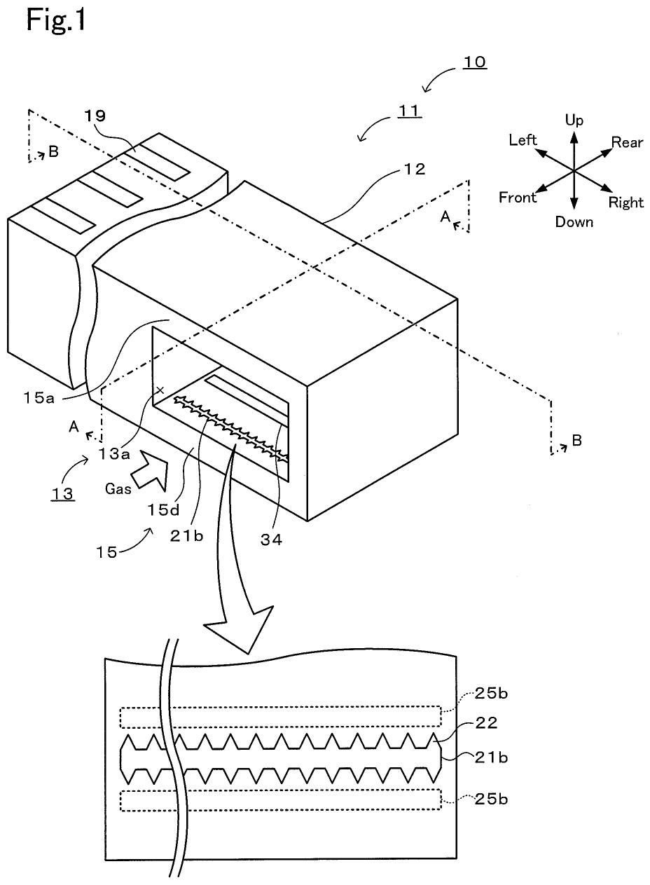

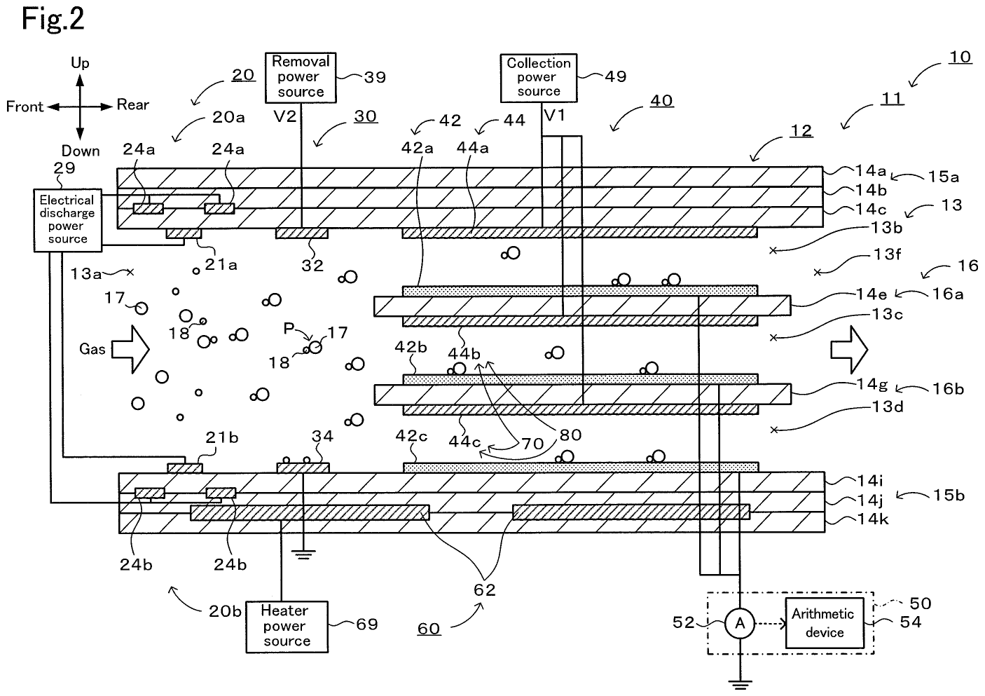

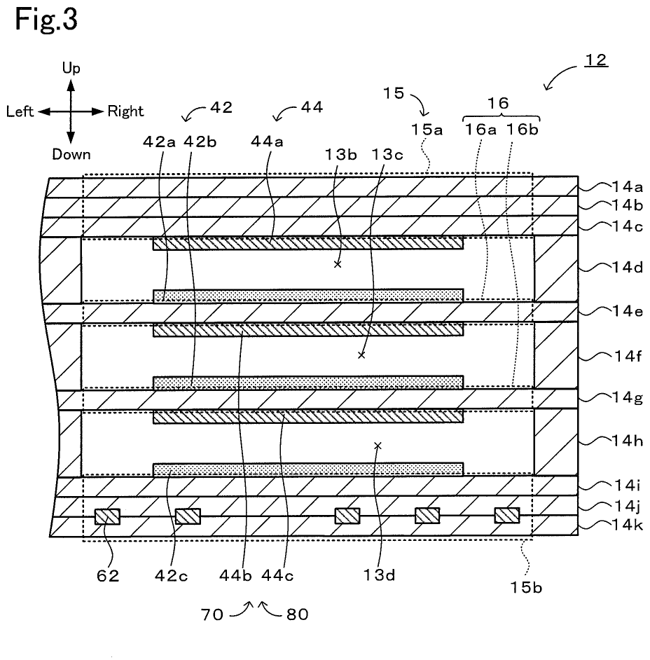

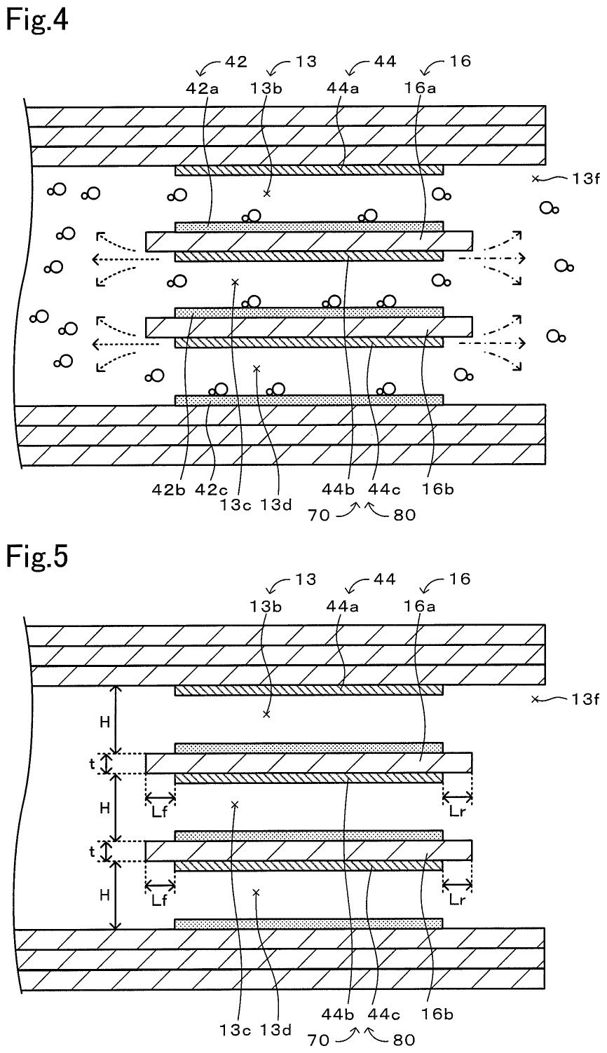

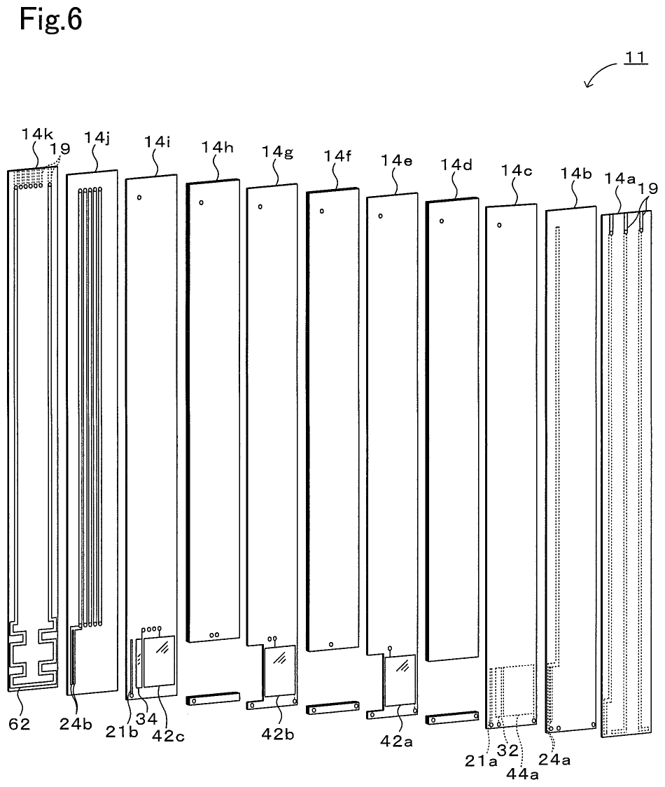

Embodiments of the present invention are described below with reference to the accompanying drawings. FIG. 1 is a perspective view of the schematic configuration of a particulate detector 10 according to an embodiment of the present invention. FIG. 2 is a cross-sectional view taken along a line A-A of FIG. 1. FIG. 3 is a partial cross-sectional view taken along a line B-B of FIG. 1. FIG. 4 is an explanatory diagram of electric fields generated by a deceleration electrode 70 and an acceleration electrode 80. FIG. 5 is an explanatory diagram of distances Lf and Lr and a distance H. FIG. 6 is an exploded perspective view of a particulate detecting element 11. Note that according to the present embodiment, the up-down direction, the left-right direction, and the front-rear direction are those illustrated in FIG. 1 to FIG. 3.

The particulate detector 10 measures the number of particulates 17 contained in gas (for example, exhaust gas of an automobile). As illustrated in FIGS. 1 and 2, the particulate detector 10 includes a particulate detecting element 11. Furthermore, as illustrated in FIG. 2, the particulate detector 10 includes an electrical discharge power source 29, a removal power source 39, a collection power source 49, a detection device 50, and a heater power source 69. As illustrated in FIG. 2, the particulate detecting element 11 includes a casing 12, a charge generating device 20, an excess charge removal device 30, a collection device 40, a heater device 60, and a deceleration electrode 70, and an acceleration electrode 80.

The casing 12 has a gas flow channel 13 thereinside. The gas flow channel 13 enables gas to flow therethrough. As illustrated in FIG. 2, the gas flow channel 13 includes a gas inlet 13a for introducing a gas into the casing 12, a plurality of (three in this example) branch flow channels 13b to 13d that are located downstream of the gas inlet 13a and that branch the gas flow, and a gas outlet 13f that is located downstream of the branch flow channels 13b to 13d and that discharges the gas to the outside of the casing 12 after the gas flows merge. The gas introduced into the casing 12 through the gas inlet 13a passes through the flow channels 13b to 13d and is discharged to the outside of the casing 12 through the gas outlet 13f. The gas flow channel 13 has a substantially rectangular cross section that is perpendicular to the central axis of the gas flow channel 13 (in this example, a cross section extending along the up-down and left-right directions). The gas inlet 13a, the branch flow channels 13b to 13d, and the gas outlet 13f all have a substantially rectangular cross section perpendicular to the central axis of the gas flow channel 13. As illustrated in FIG. 1 and FIG. 6, the casing 12 is in the form of a long, substantially rectangular parallelepiped. As illustrated in FIGS. 2, 3 and 6, the casing 12 is configured as a laminated body in which a plurality of layers (in this example, first to eleventh layers 14a to 14k) are stacked in a predetermined stacking direction (in this example, the up-down direction). The casing 12 is an insulating body, which is made of, for example, a ceramic, such as alumina. Each of the fourth to eighth layers 14d to 14h has a through-hole or a notch, and the through-holes or the notches pass through the layer in the thickness direction (in this example, the up-down direction). The through-holes or the notches form the gas flow channel 13. According to the present embodiment, the fourth, sixth, and eighth layers 14d, 14f, and 14H are thicker than the other layers. Each of the fourth, sixth, and eighth layers 14d, 14f, and 14H may be a laminated body having a plurality of layers.

As illustrated in FIGS. 2 and 3, the casing 12 has, as a wall portion of the gas flow channel 13, an outer wall 15 and a partition portion 16 which is an inner wall. The outer wall 15 has a first outer wall 15a which is part of an upper portion of the casing 12 and a second outer wall 15b which is part of the lower portion of the casing 12. The first outer wall 15a is portions of the first to third layers 14a to 14c located immediately above the gas flow channel 13. The lower surface of the first outer wall 15a constitutes a ceiling surface of the gas flow channel 13. A discharge electrode 21a, an application electrode 32, and a first electric field generating electrode 44a are disposed on the lower surface of the first outer wall 15a. The second outer wall 15b is portions of the ninth to eleventh layers 14i to 14k located immediately below the gas flow channel 13. The upper surface of the second outer wall 15b constitutes the bottom surface of the gas flow channel 13. A discharge electrode 21b, a removal electrode 34, and a third collection electrode 42c are disposed on the upper surface of the second outer wall 15b. In addition, the fourth to eighth layers 14d to 14h of the casing 12 constitute side walls (in this example, left and right wall portions) of the gas flow channel 13, and the side walls are also part of the outer wall 15.

The casing 12 has first and second partition portions 16a and 16b as the partition portion 16. The first partition portion 16a is a portion of the fifth layer 14e that faces the gas flow channel 13 (a portion located immediately below the branch flow channel 13b and immediately above the branch flow channel 13c). The first partition portion 16a separates the branch flow channel 13b from the branch flow channel 13c in the up-down direction. A first collection electrode 42a is disposed on the upper surface of the first partition portion 16a, and a second electric field generating electrode 44b is disposed on the lower surface of the first partition portion 16a. The second partition portion 16b is a portion of the seventh layer 14g that faces the gas flow channel 13 (a portion located immediately below the branch flow channel 13c and immediately above the branch flow channel 13d). The second partition portion 16b separates the branch flow channel 13c from the branch flow channel 13d in the up-down direction. The second collection electrode 42b is disposed on the upper surface of the second partition portion 16b, and the third electric field generating electrode 44c is disposed on the lower surface of the second partition portion 16b. Each of the first and second partition portions 16a and 16b is disposed inside the outer wall 15 of the casing 12 (on the side of the outer wall 15 adjacent to the gas flow channel 13).

As illustrated in FIG. 2, the charge generating device 20 includes first and second charge generating devices 20a and 20b provided inside of the casing 12 so as to be close to the gas inlet 13a. The first charge generating device 20a has the discharge electrode 21a and an ground electrode 24a disposed on the first outer wall 15a. The discharge electrode 21a and the ground electrode 24a are provided on the front side and the back side of the third layer 14c which plays a role of a dielectric layer, respectively. The discharge electrode 21a is provided on the lower surface of the first outer wall 15a and is exposed to the inside of the gas flow channel 13. The second charge generating device 20b includes a discharge electrode 21b and an ground electrode 24b disposed on the second outer wall 15b. The discharge electrode 21b and the ground electrodes 24b are provided on the front side and the back side of the ninth layer 14i which plays a role of a dielectric layer, respectively. The discharge electrode 21b is provided on the upper surface of the second outer wall 15b and is exposed to the inside of the gas flow channel 13. Each of the discharge electrodes 21a and 21b has a plurality of fine triangular protrusions 22 on the long sides of the rectangular thin metal plate facing each other (refer to FIG. 1). Each of the ground electrodes 24a and 24b is a rectangular electrode, and two ground electrodes 24a and two ground electrodes 24b are provided parallel to the long direction of the discharge electrodes 21a and 21b. The discharge electrodes 21a and 21b and the ground electrodes 24a and 24b are connected to the electrical discharge power source 29. The ground electrodes 24a and 24b are connected to the ground.

In the first charge generating device 20a, when a high voltage (for example, a pulse voltage or the like) of high frequency is applied between the discharge electrode 21a and the ground electrode 24a by the electrical discharge power source 29, aerial discharge (in this example, dielectric barrier discharge) occurs in the vicinity of the discharge electrode 21a due to the potential difference between the two electrodes. Similarly, in the second charge generating device 20b, aerial discharge occurs in the vicinity of the discharge electrode 21b due to the potential difference between the discharge electrode 21b and the ground electrode 24b caused by the high voltage applied by the electrical discharge power source 29. By these discharges, the gas present around the discharge electrodes 21a and 21b is ionized, and charges 18 (in this example, positive charges) are generated. As a result, the charges 18 are imparted to the particulates 17 in the gas flowing through the charge generating device 20, and the particulates 17 turn to charged particulates P (refer to FIG. 2).

The charge generating device 20 generates the charges 18 by dielectric barrier discharge. Thus, the charge generating device 20 can generate the amount of charge equal to that generated when, for example, the charges 18 are generated by corona discharge using a needle-like discharge electrode at a lower voltage and with lower power consumption. Since the ground electrodes 24a and 24b are embedded in the casing 12, the occurrence of short circuit between each of the ground electrodes 24a and 24b and another electrode can be prevented. Since the discharge electrodes 21a and 21b have a plurality of protrusions 22, the highly concentrated charges 18 can be generated. The discharge electrodes 21a and 21b are disposed along the inner peripheral surface of the casing 12 that is exposed to the gas flow channel 13. Consequently, the casing 12 and the discharge electrodes 21a and 21b are easily manufactured in an integrated manner, as compared with, for example, the case where needle-like discharge electrodes are disposed so as to be exposed to the gas flow channel 13. As a result, the discharge electrodes 21a and 21b are less likely to block the flow of the gas, and the particulates are less likely to adhere to the discharge electrodes 21a and 21b.

The excess charge removal device 30 includes the application electrode 32 and the removal electrode 34. The application electrode 32 and the removal electrode 34 are located downstream of the charge generating device 20 and upstream of the collection device 40. The application electrode 32 is provided on the lower surface of the first outer wall 15a and is exposed to the inside of the gas flow channel 13. The removal electrode 34 is provided on the upper surface of the second outer wall 15b and is exposed to the inside of the gas flow channel 13. The application electrode 32 and the removal electrode 34 are disposed so as to face each other. The application electrode 32 is an electrode to which a minute positive potential V2 is applied from the removal power source 39. The removal electrode 34 is an electrode connected to the ground. As a result, a weak electric field is generated between the application electrode 32 and the removal electrode 34 of the excess charge removal device 30. Consequently, of the charges 18 generated by the charge generating device 20, the excess charges 18 that have not been imparted to the particulates 17 are attracted to the removal electrode 34 by the weak electric field and are captured by the removal electrode 34. Thereafter, the excess charges 18 are discarded to the ground. As a result, the excess charge removal device 30 prevents the excess charges 18 from being collected by a collection electrode 42 of the collection device 40 and being counted up and added to the number of particulates 17.

The collection device 40 is a device for collecting a collection target (in this example, the charged particulates P). The collection device 40 is provided in the branch flow channels 13b to 13d at a position downstream of the charge generating device 20 and the excess charge removal device 30. The collection device 40 includes at least one collection electrode 42 for collecting the charged particulates P and at least one electric field generating electrode 44 for moving the charged particulates P toward the collection electrode 42. According to the present embodiment, the collection device 40 includes the first to third collection electrodes 42a to 42c as the collection electrodes 42 and the first to third electric field generating electrodes 44a to 44c as the electric field generating electrodes 44. The collection electrode 42 and the electric field generating electrode 44 are provided so as to be exposed to the gas flow channel 13. The first collection electrode 42a and the first electric field generating electrode 44a form a pair of electrodes. Similarly, the second collection electrode 42b and the second electric field generating electrode 44b form a pair of electrodes. The third collection electrode 42c and the third electric field generating electrode 44c form a pair of electrodes. That is, the collection device 40 has a plurality of pairs (in this example, three pairs) of electrodes. The two electrodes in each pair (one of the collection electrodes 42 and one of the electric field generating electrodes 44 that form the pair) are disposed so as to face each other in the up-down direction. The first to third electric field generating electrodes 44a to 44c generate the collection electric fields for moving the charged particulates P toward the first to third collection electrodes 42a to 42c that form pairs therewith, respectively. Each of the plurality of pairs of electrodes are provided in one of the branch flow channels 13b to 13c. More specifically, the first electric field generating electrode 44a is disposed on the lower surface of the first outer wall 15a, and the first collection electrode 42a is disposed on the upper surface of the first partition portion 16a. The second electric field generating electrode 44b is disposed on the lower surface of the first partition portion 16a, and the second collection electrode 42b is disposed on the upper surface of the second partition portion 16b. The third electric field generating electrode 44c is disposed on the lower surface of the second partition portion 16b, and the third collection electrode 42c is disposed on the upper surface of the second outer wall 15b.

A voltage V1 is applied to each of the first to third electric field generating electrodes 44a to 44c from the collection power source 49. The first to third collection electrodes 42a to 42c are all connected to the ground via an ammeter 52. As a result, a collection electric field radiating from the first electric field generating electrode 44a to the first collection electrode 42a is generated in the branch flow channel 13b. A collection electric field radiating from the second electric field generating electrode 44b to the second collection electrode 42b is generated in the branch flow channel 13c, and a collection electric field radiating from the third electric field generating electrode 44c to the third collection electrode 42c is generated in the branch flow channel 13d. Consequently, each of the charged particulates P flowing through the gas flow channel 13 enters any one of the branch flow channels 13b to 13d and is moved downward by the collection electric field generated in the branch flow channel. Thereafter, the charged particulate P is attracted to any one of the first to third collection electrodes 42a to 42c and is collected. In this example, the voltage V1 is a positive potential, and the level of the voltage V1 is, for example, on the order of 100 V to several kV. The size of each of the electrodes 34 and 42 and the strength of the electric field on each of the electrodes 34 and 42 (that is, the magnitude of the voltage V1 or V2) are determined such that the charged particulates P are collected by the collection electrode 42 without being collected by the removal electrode 34 and, in addition, the charges 18 not imparted to the particulates 17 are collected by the removal electrode 34.

Among the electric field generating electrodes 44, the second and third electric field generating electrodes 44b and 44c disposed in the partition portion 16 further function as deceleration electrodes, and these electrodes are also referred to as “deceleration electrodes 70”. The deceleration electrodes 70 are electrodes for generating deceleration electric fields that decelerate the object to be collected (in this example, the charged particulates P) upstream of the collection electrodes 42 in the direction of the gas flow. The deceleration electrodes 70 are disposed in the partition portion 16 of the casing 12 and are away from the outer walls 15. When the voltage V1 is applied to the second and third electric field generating electrodes 44b and 44c serving as the deceleration electrodes 70, a deceleration electric field is generated in addition to the above-described collection electric field. As denoted by the broken line arrows in FIG. 4, the deceleration electric field is an electric field mainly radiated from the upstream end (in this example, the front end) of each of the second and third electric field generating electrodes 44b and 44c and the surrounding vicinity in the upstream direction of the gas flow channel 13. The charged particulates P flowing through the gas flow channel 13 are decelerated upstream of the collection electrode 42 by the deceleration electric field and, thereafter, enter the branch flow channels 13b to 13d. Thus, the charged particulates P are collected by the collection electrode 42. The voltage V1 is determined in consideration of the magnitude of the decelerating effect of the deceleration electric field on the charged particulates P. For example, the voltage V1 may be set such that the deceleration electric field can decelerate the charged particulates P without pushing back the charged particulates P toward the upstream.

In terms of the position of the deceleration electrode 70, it is desirable that a distance Lf illustrated in FIG. 5 be minimized. For example, it is desirable that the distance Lf be less than or equal to the distance H. The distance Lf is the distance, in the central axis direction of the gas flow channel 13, between an end (in this example, the front end) of the partition portion 16 in the gas flow direction and the deceleration electrode 70. The distance H is the distance, in a direction perpendicular to the central axis of the gas flow channel 13, between the partition portion 16 and the wall portion of the casing 12. The distance H is equal to the channel thickness of each of the branch flow channels 13b to 13d which are partitioned by the partition portion 16. The distance Lf is the length in the axial direction of a portion of the partition portion 16 that is located upstream of the deceleration electrode 70 in the gas flow direction. If the distance Lf is large, this portion may prevent the deceleration of the charged particulates P controlled by the deceleration electric field. As the distance Lf decreases, the partition portion 16 is less likely to prevent the deceleration of the charged particulates P controlled by the deceleration electric field. According to the present embodiment, each of the second and third electric field generating electrodes 44b and 44c satisfies the condition Lf≤H. The values of the distance Lf and the distance H are calculated independently for each of the deceleration electrodes 70 (the second and third electric field generating electrodes 44b and 44c). For example, the distance H to be compared with the distance Lf of the second electric field generating electrode 44b is set to the smaller one of the channel thicknesses of the branch flow channel 13b and the branch flow channel 13c, which are partitioned by the first partition portion 16a. The channel thickness of the branch flow channel 13d has no relation. The distance Lf may be set to 0.1 mm or more. The distance Lf may be set to 2.0 mm or less. The distance H may be set to 0.01 mm or more. When the distance H is 0.01 mm or more, the gas easily enters the branch flow channel. The distance H may be set to 6 mm or less. When the distance H is 6 mm or less, a sufficient effect of the charged electric field moving the charged particulates P toward the collection electrode 42 can be easily obtained. A thickness t of the partition portion 16 may be set to, for example, 0.02 mm or more. When the thickness t is 0.02 mm or more, cracking of the partition portion 16 can be prevented. The thickness t may be set to 0.5 mm or less. When the thickness t is 0.5 mm or less, the size of the casing 12 can be reduced in the thickness direction since the partition portion 16 is thin.

Among the electric field generating electrodes 44, the second and third electric field generating electrodes 44b and 44c disposed in the partition portion 16 further function as the acceleration electrodes, and these electrodes are also referred to as “acceleration electrodes 80”. The acceleration electrode 80 is an electrode for generating an acceleration electric field that accelerates the charged particulates P downstream of the collection electrode 42 in the gas flow direction. The acceleration electrode 80 is disposed in the partition portion 16 of the casing 12 and is away from the outer wall 15. When the voltage V1 is applied to the second and third electric field generating electrodes 44b and 44c serving as the acceleration electrodes 80, an acceleration electric field is generated in addition to the above-described collection electric field and deceleration electric field. As denoted by the alternate long and short dash line arrows in FIG. 4, the acceleration electric field is an electric field mainly radiated from the downstream end (in this example, the rear end) of each of the second and third electric field generating electrodes 44b and 44c and its vicinity in the downstream direction of the gas flow channel 13. The charged particulates P not collected by the collection electrode 42 are accelerated downstream of the collection electrode 42 by the acceleration electric field and are discharged from the gas outlet 13f to the outside of the casing 12. The voltage V1 is determined in consideration of the magnitude of the acceleration effect of the acceleration electric field on the charged particulates P.

In terms of the position of the acceleration electrode 80, it is desirable that the distance Lr illustrated in FIG. 5 be small. For example, it is desirable that the distance Lr be less than or equal to the distance H described above. The distance Lr is a distance, in the central axis direction of the gas flow channel 13, between the downstream end (in this example, the rear end) of the partition portion 16 in the gas flow direction and the acceleration electrode 80. The distance Lr is the length in the axial direction of a portion of the partition portion 16 located downstream of the acceleration electrode 80 in the gas flow direction. If the distance Lr is large, this portion may prevent the acceleration of the charged particulates P controlled by the acceleration electric field. As the distance Lr decreases, the partition portion 16 is less likely to prevent the acceleration of the charged particulates P controlled by the acceleration electric field. According to the present embodiment, each of the second and third electric field generating electrodes 44b and 44c satisfies the condition Lr≤H. The values of the distance Lr and the distance H are calculated independently for each of the acceleration electrodes 80 (the second and third electric field generating electrodes 44b and 44c). For example, the distance H to be compared with the distance Lr of the second electric field generating electrode 44b is set to the smaller one of the channel thicknesses of the branch flow channel 13b and the branch flow channel 13c, which are partitioned by the first partition portion 16a. The channel thickness of the branch flow channel 13d has no relation. The distance Lr may be set to 0.1 mm or more. The distance Lr may be set to 2.0 mm or less.

The detection device 50 includes the ammeter 52 and an arithmetic device 54. One terminal of the ammeter 52 is connected to the collection electrode 42, and the other terminal is connected to the ground. The ammeter 52 measures an electric current based on the charges 18 of the charged particulates P collected by the collection electrode 42. The arithmetic device 54 calculates the number of particulates 17 on the basis of the electric current measured by the ammeter 52. The arithmetic device 54 may have the function of a control unit that controls each of the devices 20, 30, 40, and 60 by controlling the on/off and voltage of each of the power sources 29, 39, 49, and 69.

The heater device 60 includes a heater electrode 62 that is disposed between the tenth layer 14j and the eleventh layer 14k and that is embedded in the second outer wall 15b. The heater electrode 62 is, for example, a strip-shaped heating element extending in a zigzag manner. According to the present embodiment, the heater electrode 62 extends over the substantially entire region directly below the gas flow channel 13. The heater electrode 62 is connected to the heater power source 69. The heater electrode 62 generates heat when energized by the heater power source 69. The heater electrode 62 heats the casing 12 and each of the electrodes, such as the collection electrode 42.

As illustrated in FIGS. 1 and 6, a plurality of terminals 19 are disposed on the upper and lower surfaces of the left end portion of the casing 12. Each of the electrodes 21a, 21b, 24a, 24b, 32, 34, 42, and 44 described above is electrically connected to one of the plurality of terminals 19 via a wire disposed in the casing 12. Similarly, the heater electrode 62 is electrically connected to two of the terminals 19 via wires. The wires are disposed, for example, on the upper and lower surfaces of the first to eleventh layers 14a to 14k. Alternatively, the wires are disposed in through-holes provided in the first to eleventh layers 14a to 14k. Although not illustrated in FIG. 2, the power sources 29, 39, 49, and 69 and the ammeter 52 are electrically connected to the electrodes in the particulate detecting element 11 via the terminals 19.

A method for manufacturing the particulate detecting element 11 configured in this manner is described below. A plurality of unsintered ceramic green sheets containing raw material ceramic powders are prepared so as to correspond to the first to eleventh layers 14a to 14k first. Spaces to form the gas flow channels 13 and through-holes are formed in the green sheets corresponding to the fourth to eighth layers 14d to 14H in advance by a punching process or the like. Subsequently, to form a variety of patterns on each of the ceramic green sheets corresponding to the first to eleventh layers 14a to 14k, a pattern printing process and a drying process are performed. More specifically, the patterns to be formed are patterns of, for example, the above-described electrodes, wires connected to the electrodes, terminals 19, and the like. The pattern printing is performed by applying a pattern forming paste on the green sheet by using a widely known screen printing technique. In addition, during the pattern printing process or before and after the pattern printing process, the through-holes are filled with a conductive paste that forms the wires. Subsequently, a printing process and a drying process of a bonding paste used to stack and bond the green sheets are performed. Thereafter, the green sheets each having the bonding paste formed thereon are stacked in a predetermined order, and a pressure bonding process is performed by applying predetermined temperature and pressure conditions to the green sheets to form a single laminated body. When the pressure bonding process is performed, the spaces for forming the gas flow channels 13 are filled with an eliminable material (for example, theobromine) which disappears by sintering. Thereafter, the laminated body is cut into a laminated body having a size that fits the casing 12. Subsequently, the cut-out laminated body is sintered at a predetermined sintering temperature. Since the eliminable material disappears at the time of sintering, the portion filled with the eliminable material turns to the gas flow channel 13. Thus, the particulate detecting element 11 is obtained.

As described above, the casing 12 made of a ceramic material is desirable, because the following effects can be obtained. In general, the ceramic material has high heat resistance. Thus, as described below, the casing 12 easily withstands a temperature for removing particulates 17 by the heater electrode 62 (for example, a temperature as high as 600° C. to 800° C. at which carbon which is the main component of the particulates 17 burns). Furthermore, since in general, the ceramic material has a high Young's modulus, the rigidity of the casing 12 can be easily maintained even when the thickness of the outer wall 15 and the thickness of the partition portion 16 of the casing 12 are reduced. Thus, deformation of the casing 12 due to thermal shock or an external force can be prevented. Since deformation of the casing 12 is prevented, a decrease in accuracy of detecting the number of particulates is prevented which is caused by a change in the electric field distribution inside the gas flow channel 13 at the time of discharge of the charge generating device 20 and a change in the channel thickness of each of the branch flow channels 13b to 13d (in this example, the height in the up-down direction), for example. As a result, if the casing 12 is made of a ceramic material, the thickness of the outer wall 15 and the thickness of the partition portion 16 of the casing 12 can be reduced without deformation of the casing 12. Thus, the casing 12 can be made compact. Examples of a ceramic material include but not limited to alumina, silicon nitride, mullite, cordierite, magnesia, and zirconia.

A usage example of the particulate detector 10 is described below. When measuring particulates contained in the exhaust gas of a car, the particulate detecting element 11 is mounted in the exhaust duct of the engine. At this time, the particulate detecting element 11 is attached such that the exhaust gas is introduced into the casing 12 through the gas inlet 13a, passes through the branch flow channels 13b to 13d, and is discharged. Furthermore, the power sources 29, 39, 49, and 69 and the detection device 50 are connected to the particulate detecting element 11.

The particulates 17 contained in the exhaust gas introduced into the casing 12 through the gas inlet 13a are given the charges 18 (in this example, positive charges) generated by the discharge of the charge generating device 20 and, thus, turn to the charged particulates P. The charged particulates P directly pass through the excess charge removal device 30, which has a weak electric field and has a length of the removal electrode 34 shorter than the length of the collection electrode 42, and flows into any one of the branch flow channels 13b to 13d. Thus, the charged particulates P reach the collection device 40. In contrast, the charges 18 that are not given to the particulates 17 are attracted to the removal electrode 34 of the excess charge removal device 30 even if the electric field is weak. Thereafter, the charges 18 are discarded to GND via a removal electrode 34. In this manner, unnecessary charges 18 which have not been imparted to the particulates 17 hardly reach the collection device 40.

The charged particulates P that have reached the collection device 40 are collected by any one of the first to third collection electrodes 42a to 42c by the collection electric field generated by the electric field generating electrode 44. Thereafter, an electric current based on the charges 18 of the charged particulates P attached to the collection electrode 42 is measured by the ammeter 52, and the arithmetic device 54 calculates the number of the particulates 17 on the basis of the electric current. According to the present embodiment, the first to third collection electrodes 42a to 42c are connected to the single ammeter 52, and an electric current is measured by the ammeter 52 on the basis of the total number of the charges 18 of the charged particulates P attached to the first to third collection electrodes 42a to 42c. The relationship between the current 1 and the charge amount q is defined by 1=dq/(dt), q=∫1dt. The arithmetic device 54 integrates (accumulates) the current value over a predetermined period of time to obtain the integral value (the accumulated charge amount) and divides the accumulated charge amount by the elementary charge to obtain the total number of charges (the number of collected charges). Thereafter, the arithmetic device 54 divides the number of collected charges by the average value of the number of charges imparted to one particulate 17 (the average number of charges). In this manner, the arithmetic device 54 obtains the number Nt of the particulates 17 attached to the collection electrode 42. The arithmetic device 54 detects the number Nt as the number of particulates 17 in the exhaust gas. Note that in some cases, some of the particulates 17 are not collected by the collection electrode 42 and pass over the collection electrode 42 or adhere to the inner peripheral surface of the casing 12 before being collected by the collection electrode 42. Accordingly, the collection efficiency of the particulates 17 may be determined in advance in consideration of the percentage of the particulates 17 not collected by the collection electrode 42, and the arithmetic device 54 may divide the number Nt by the collection efficiency to obtain a total number Na that represents the number of particulates 17 in the exhaust gas.

As described above, when the charged particulates P are collected by the collection electrode 42, the deceleration electrode 70 generates the above-described deceleration electric field to decelerate the charged particulates located upstream of the collection electrode 42 in the gas flow direction. In addition, the deceleration electrode 70 is disposed in the partition portion 16 and is away from the outer wall 15 of the gas flow channel 13. That is, as compared with, for example, the deceleration electrode 70 disposed along the inner peripheral surface of the outer wall 15 of the gas flow channel 13, the deceleration electrode 70 is positioned closer to the central axis of the gas flow channel 13. Therefore, the deceleration electric field is likely to act on a region near the central axis of the gas flow channel 13, which is a region where the flow velocity is relatively high. In this manner, the charged particulates P having a relatively high flow velocity can be decelerated by the deceleration electric field. Due to the action of the deceleration electric field, the number of charged particulates P which are not collected by the collection electrode 42 and pass through the collection electrode 42 can be reduced and, thus, the collection electrode 42 can easily collect the charged particulates P. As a result, for example, the collection efficiency of the charged particulates P by the collection electrode 42 is improved. Alternatively, the length of the collection electrode 42 (the length in the axial direction of the gas flow channel 13) is reduced. Consequently, the casing 12 can be made compact.

Note that even when the collection electric field and the deceleration electric field are generated, there may be the case where some of the charged particulates P are not collected by the collection electrode 42 and pass over the collection electrode 42. In this case, the acceleration electrode 80 generates the above-described acceleration electric field to accelerate the charged particulates P located downstream of the collection electrode 42 in the gas flow direction. Moreover, the acceleration electrode 80 is disposed in the partition portion 16 and is away from the outer wall 15 of the gas flow channel 13. That is, as compared with for example, the acceleration electrode 80 is disposed along the inner peripheral surface of the outer wall 15 of the gas flow channel 13, the acceleration electrode 80 is positioned closer to the central axis of the gas flow channel 13. Therefore, the acceleration electric field easily act on a wide range of charged particulates P. Due to the action of the acceleration electric field, some of the charged particulates P which are not collected by the collection electrode 42 are accelerated and rapidly discharged to the outside of the casing 12. Consequently, the charged particulates P which are not collected by the collection electrode 42 can be prevented from adhering to the casing 12. For example, the charged particulates P can be prevented from adhering to the inner peripheral surface of the outer wall 15 of the casing 12 and the rear end surface of the partition portion 16. As a result, the occurrence of a defect due to adhesion of the charged particulates P can be prevented. For example, clogging of the gas flow channel 13 due to adhesion of the charged particulates P to the casing 12 can be prevented. In addition, a short circuit between electrodes caused by the charged particulates P attached to the casing 12 (in this example, a short circuit between the collection electrode 42 and the electric field generating electrode 44) can be prevented.

Note that among the electric field generating electrodes 44, the first electric field generating electrode 44a having no portion separated from the outer wall 15 is not included in the deceleration electrodes 70 according to the present embodiment. The reason is as follows: The first electric field generating electrode 44a is disposed along the inner peripheral surface of the outer wall 15 and is not separated from the outer wall 15. Thus, the charged particulates P passing near the first electric field generating electrode 44a have a relatively low flow velocity. Therefore, even when the electric field generated near the front end portion of the first electric field generating electrode 44a decelerates the charged particulates P, the ease of collection of the charged particulates P by the collection electrode 42 is not significantly improved.

Similarly, the first electric field generating electrode 44a is not included in the acceleration electrodes 80 according to the present embodiment. The reason is as follows: As described above, the first electric field generating electrode 44a is disposed along the inner peripheral surface of the outer wall 15 and is not separated from the outer wall 15. In addition, since the first electric field generating electrode 44a generates a collection electric field, the charged particulates P move away from the first electric field generating electrode 44a and move downward as they pass through the branch flow channel 13b. Therefore, the concentration of charged particulates P is low around the rear end portion of the first electric field generating electrode 44a. As a result, the electric field generated near the rear end portion of the first electric field generating electrode 44a does not significantly act on the charged particulates P, and the effect of preventing adhesion of the charged particulates P to the casing 12 is not significantly improved. In contrast, for example, although in the vicinity of the rear end portion of the second electric field generating electrode 44b, the concentration of the charged particulates P is low in a region adjacent to the branch flow channel 13c due to the collection electric field generated by the first electric field generating electrode 44a, the concentration of the charged particulates P that are not collected by the first collection electrode 42a is high in a region adjacent to the branch flow channel 13b. Therefore, the second electric field generating electrode 44b disposed in the first partition portion 16a can accelerate the charged particulates P by the electric field generated by the rear end portion of the second electric field generating electrode 44b. Thus, an effect of preventing adhesion of the charged particulates P to the casing 12 can be sufficiently obtained. For this reason, the second electric field generating electrode 44b is included in the acceleration electrodes 80. For the same reason, the third electric field generating electrode 44c is included in the acceleration electrodes 80.

Furthermore, as compared with the electric fields generated near the rear end portion of the second and third electric field generating electrodes 44b and 44c, the electric field generated near the rear end portion of the first electric field generating electrode 44a acts on only the charged particulates P in a narrow range. Therefore, even when the electric field generated near the rear end portion of the first electric field generating electrode 44a accelerates the charged particulates P, the effect of preventing adhesion of the charged particulates P to the casing 12 is not significantly improved. In addition, according to the present embodiment, the deceleration electric field of the deceleration electrode 70 decelerates the charged particulates P located upstream of the rear end portion of the acceleration electrode 80. Therefore, as compared with the vicinity of the rear end portion of the acceleration electrode 80 (the region near the central axis of the gas flow channel 13), the flow velocity of the charged particulates P is not significantly slow around the rear end portion of the first electric field generating electrode 44a (the region of the gas flow channel 13 near the inner peripheral surface of the outer wall 15) (that is, the difference in the flow velocity is small). Accordingly, the electric field generated by the rear end portion of the first electric field generating electrode 44a and its vicinity does not significantly contribute to the effect of preventing adhesion of the charged particulates P to the casing 12. For these additional reasons, the first electric field generating electrode 44a of the present embodiment is not included in the acceleration electrodes 80.

If many particulates 17 and the like are deposited on the collection electrode 42 with the use of the particulate detecting element 11, there may be the case where the charged particulates P are not collected more by the collection electrode 42. Therefore, the collection electrode 42 is heated by the heater electrode 62 periodically or at a time when the amount of deposition reaches a predetermined amount. In this manner, the deposition on the collection electrode 42 is heated and incinerated so that the electrode surface of the collection electrodes 42 is refreshed. In addition, the particulates 17 attached to the inner peripheral surface of the casing 12 can be incinerated by the heater electrode 62.

The correspondence between the components of the present embodiment and the components of the present invention is clarified below. The casing 12 of the present embodiment corresponds to a casing of the present invention, the charge generating device 20 corresponds to a charge generation portion, the collection electrode 42 corresponds to a collection electrode, and the deceleration electrodes 70 (in this example, the second and third electric field generating electrodes 44b and 44c) correspond to deceleration electrodes. In addition, the partition portion 16 corresponds to a partition portion and a deceleration electrode arrangement member, and the detection device 50 corresponds to a detection unit.

In the particulate detecting element 11 of the present embodiment described in detail above, since the deceleration electric field generated by the deceleration electrode 70 decelerates the charged particulates P, the charged particulates P can be easily collected by the collection electrode 42.

In addition, the casing 12 has a partition portion 16 that divides the gas flow channel 13 into the plurality of branch flow channels 13b to 13d. In addition, the first collection electrodes 42a to 42c are disposed in the plurality of branch flow channels 13b to 13d, respectively. The presence of the collection electrode 42 disposed in each of the plurality of branch flow channels 13b to 13d in this manner facilitates collection of the charged particulates P by the collection electrode 42. As a result, for example, the number of charged particulates P not collected by the collection electrode 42 can be reduced, and the number of charged particulates P adhering to the wall portion of the casing 12 can be reduced. Alternatively, the length of the collection electrode 42 (the length in the axial direction of the gas flow channel 13) can be reduced and, thus, the casing 12 can be made compact.

Furthermore, the particulate detecting element 11 includes at least one electric field generating electrode 44 that generates a collection electric field for moving the charged particulates P toward the collection electrode 42 disposed in at least one of the plurality of branch flow channels 13b to 13d. In this manner, the particulate detecting element 11 can move the charged particulates P toward the collection electrode 42 by the collection electric field in addition to decelerating the charged particulates P by the deceleration electric field. As such, the particulate detecting element can more easily collect the charged particulates P by using the collection electrodes 42. Furthermore, the particulate detecting element 11 defines a pair consisting of one of the collection electrodes 42 and one of the electric field generating electrodes 44 and includes a plurality of the pairs (three pairs in this example) each disposed in one of the plurality of branch flow channels 13b to 13d. As a result, the charged particulates P can be more easily collected by the collection electrodes 42.

Still furthermore, the second and third electric field generating electrodes 44b and 44c disposed in the partition portion 16 further function as the deceleration electrodes 70. As a result, the device configuration of the particulate detecting element 11 can be made compact, as compared with the configuration including the electric field generating electrode 44 and the deceleration electrode 70 provided separately.

In addition, since the casing 12 includes the deceleration electrode arrangement member (in this example, the partition portion 16) on which the deceleration electrodes 70 are disposed on the inner side of the outer wall 15, the deceleration electrodes 70 can be supported by the deceleration electrode arrangement member. Moreover, since the partition portion 16 further functions as the deceleration electrode arrangement member, the device configuration of the particulate detecting element 11 can be made more compact than in the case where both are provided separately.

Yet still furthermore, since as illustrated in FIG. 5, the particulate detecting element 11 satisfies the condition Lf≤H, the length in the axial direction of the partition portion 16 located upstream of the deceleration electrode 70 in the gas flow direction (=the distance Lf) is relatively small. As a result, the partition portion 16 is less likely to prevent deceleration of the charged particulates P by the deceleration electric field.

It is to be understand that the present invention is not limited to the above-described embodiment at all, but intended to include a variety of forms within the technical scope of the present invention.

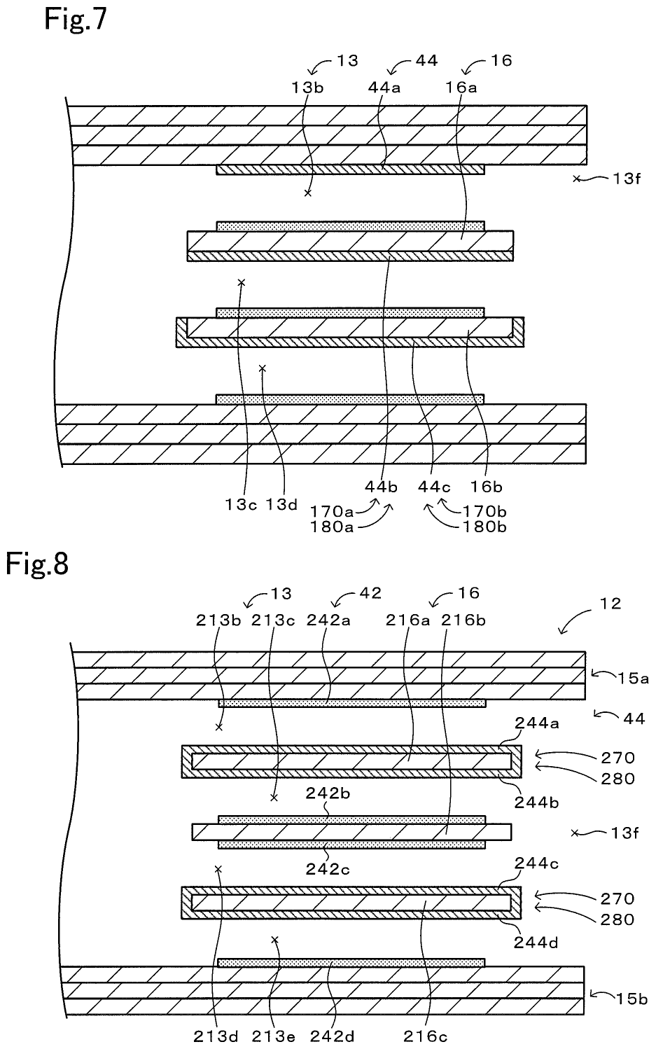

For example, according to the embodiment described above, the distance Lf is larger than the value 0, as illustrated in FIG. 5. As described above, it is desirable that the value of the distance Lf be small, and it is more desirable that the value Lf be zero. For example, deceleration electrodes 170a and 170b of a modification illustrated in FIG. 7 both extend to the upstream end (in this example, the front end) of a deceleration electrode arrangement member (in this example, a partition portion 16) in the gas flow direction. Thus, the distance Lf has a value of 0. In addition, the deceleration electrode 170b is further disposed on the upstream end surface (in this example, the front end surface) of the deceleration electrode arrangement member (in this example, the second partition portion 16b) in the gas flow direction. Since the front end surface of the partition portion 16b is a surface facing the oncoming gas flow, the further presence of the deceleration electrode 170b on this surface increases the deceleration effect of the deceleration electric field generated by the deceleration electrode 170b on the charged particulates P. That is, the deceleration effect of the charged particulate P of the deceleration electrode 170b is more significant than that of the deceleration electrode 170a. It is desirable that the portion of the deceleration electrode 170b located at the front end surface of the second partition portion 16b be 0.5 mm or less in thickness. In this way, the electrode on this portion can be prevented from peeling off.

Like the distance Lf, it is desirable that the distance Lr have a value of 0. For example, according to the modification illustrated in FIG. 7, the distance Lr has a value of 0 for acceleration electrodes 180a and 180b and the partition portion 16. The acceleration electrode 180b is further disposed on the downstream end surface (in this example, the rear end surface) of an acceleration electrode arrangement member (in this example, the second partition portion 16b) in the gas flow direction. Since the downstream end surface of the second partition portion 16b is a surface facing the downstream of the gas flow, the further presence of the acceleration electrode 180b on this surface increases the acceleration effect of the acceleration electric field on the charged particulates P.

According to the embodiment described above, as illustrated in FIG. 2, the front end of the deceleration electrode 70 and the front end of the collection electrode 42 are located at the same position in the central axis direction of the gas flow channel 13. However, like the deceleration electrodes 170a and 170b illustrated in FIG. 7, the front end of the deceleration electrode 70 may extend in the upstream direction of the gas flow channel 13 beyond the front end of the collection electrode 42. Conversely, the front end of the collection electrode 42 may extend in the upstream direction of the gas flow channel 13 beyond the front end of the deceleration electrode 70. The same applies to the positional relationship between the electric field generating electrode 44 and the collection electrode 42 and the positional relationship between the acceleration electrode 80 and the collection electrode 42.

According to the embodiment described above, as illustrated in FIG. 2, the rear end of the deceleration electrode 70 and the rear end of the collection electrode 42 are located at the same position in the central axis direction of the gas flow channel 13. However, like the deceleration electrodes 170a and 170b illustrated in FIG. 7, the rear end of the deceleration electrode 70 may extend in the downstream direction of the gas flow channel 13 beyond the rear end of the collection electrode 42. As described above, the deceleration electrode 70 further functions as the acceleration electrode 80. Therefore, if the position of the rear end of the deceleration electrode 70 in the central axis direction of the gas flow channel 13 is the same as that of the rear end of the collection electrode 42 or is located downstream of the rear end of the collection electrodes 42, collection of the charged particulates P by the collection electrodes 42 is less likely to be prevented, although the acceleration electric field accelerates the charged particulates P. However, the rear end of the deceleration electrode 70 may be located upstream of the rear end of the collection electrode 42 in the central axis direction of the gas flow channel 13. In this case, the acceleration electric field may prevent the collection of the charged particulates P by the collection electrode 42, depending on the distance between the rear end of the deceleration electrode 70 and the rear end of the collection electrode 42 in the central axis direction of the gas flow channel 13. However, the effect of the acceleration electric field that prevents adhesion of the charged particulates P to the casing 12 is obtained. The same applies to the positional relationship between the electric field generating electrode 44, which further functions as the acceleration electrode 80, and the collection electrode 42.

According to the embodiment described above, the first collection electrode 42a is disposed on the upper surface of the first partition portion 16a, and the second electric field generating electrode 44b is disposed on the lower surface. However, the positions of the electrodes are not limited thereto. For example, one of two electrodes having the same function may be disposed on the upper surface, and the other may be disposed on the lower surface. For example, one of the collection electrodes 42 may be disposed on the upper surface and the other on the lower surface of the first partition portion 16a, one of the electric field generating electrodes 44 may be disposed on the upper surface and the other on the lower surface, or one of the deceleration electrodes 70 may be disposed on the upper surface and the other on the lower surfaces. In this manner, at least some of the wires and the terminals 19 disposed on the casing 12 can be shared to electrically connect the electrodes on both the upper and lower surfaces to an external device.

According to the embodiment described above, the casing 12 has the first and second partition portions 16a and 16b as the partition portions 16. However, the number of partition portions may be one or three or more. The casing 12 does not necessarily have to have the partition portion 16.

According to the embodiment described above, a configuration illustrated in FIG. 8 may be adopted. As illustrated in FIG. 8, the casing 12 has first to third partition portions 216a to 216c as the partition portions 16, and the gas flow channel 13 branches into four (branch flow channels 213b to 213e). The branch flow channels 213b to 213e have the first to fourth collection electrodes 242a to 242d and the first to fourth electric field generating electrodes 244a to 244d disposed therein, respectively, and each of the branch flow channels 213b to 213e has a pair of electrodes (a pair consisting of the collection electrode 42 and electric field generating electrode 44) disposed therein. Two electrodes of the same type are disposed on the partition portion 16, one on the upper surface and the other on the lower surface. More specifically, one of the electric field generating electrodes 44 is disposed on the upper surface and the other on the lower surface of each of the first partition portion 216a and the third partition portion 216c. One of the collection electrodes 42 is disposed on the upper surface and the other on the lower surface of the second partition portion 216b. In addition, the first collection electrode 242a is disposed on the lower surface of the first outer wall 15a, and the fourth collection electrode 242d is disposed on the upper surface of the second outer wall 15b. All of the first to fourth electric field generating electrodes 244a to 244d further serve as the deceleration electrodes 270 and the acceleration electrodes 280. In addition, the first and second electric field generating electrodes 244a and 244b are connected to each other by electrodes disposed on the front end surface and the rear end surface of the first partition portion 16a, and all of these electrodes constitute one deceleration electrode 270 and one acceleration electrode 80 (thus, each of the distances Lf and Lr has a value of 0). The same applies to the third and fourth electric field generating electrodes 244c and 244d. In the example illustrated in FIG. 8, since each of the four electric field generating electrodes 44 is disposed in the partition portion 16 and is away from the outer wall 15, any one of the electric field generating electrodes 44 can function as the deceleration electrode 270 and the acceleration electrode 80. Moreover, since electrodes having the same function are disposed on both surfaces of the partition portion 16, the wires and the terminals 19 can be shared as much as possible, as described above. In addition to the example illustrated in FIG. 8, if the number of partition portions 16 is an odd number, electrodes having the same function can be disposed on both surfaces of the partition portion 16, as in the case illustrated in FIG. 8, and each of the electric field generating electrodes 44 can function as the deceleration electrode 270 and the acceleration electrode 80.

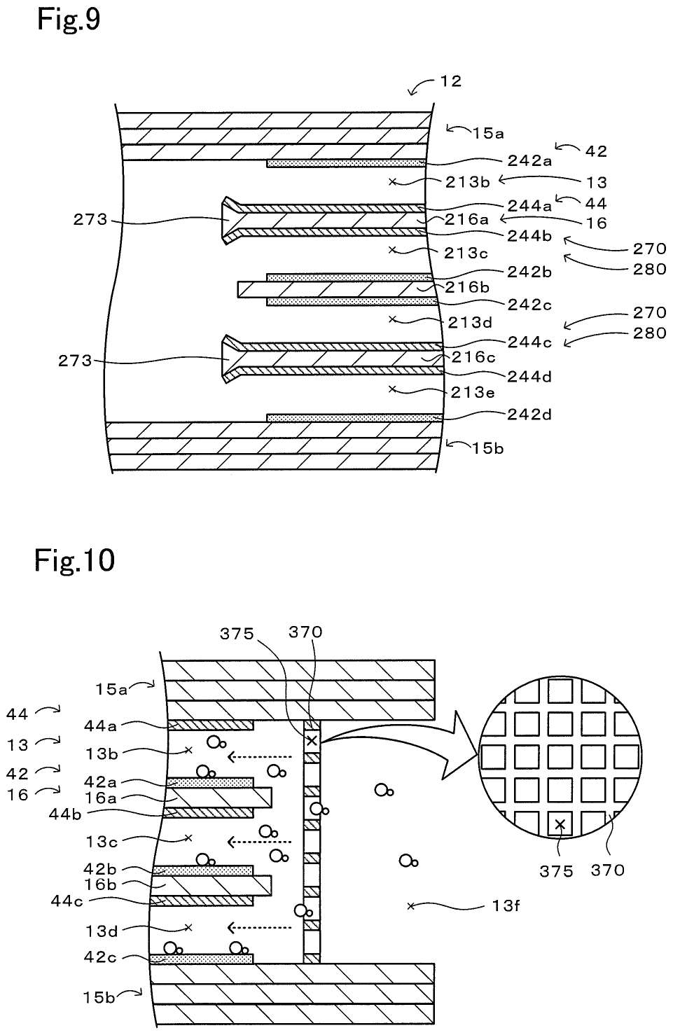

A shape illustrated in FIG. 9 may be employed as the shape of the deceleration electrode arrangement member. FIG. 9 illustrates an example of the modification illustrated in FIG. 8 in which the first and third partition portions 216a and 216c each having the deceleration electrode 270 disposed thereon have a decelerating structure 273. As illustrated in FIG. 9, each of the first and third partition portions 216a and 216c has the decelerating structure 273 at the front end. The decelerating structure 273 has a shape in which the thickness of the partition portion 16 increases toward the front end. Therefore, when the first partition portion 216a is viewed in a cross section perpendicular to the central axis of the gas flow channel 13, the decelerating structure 273 has a shape with a cross-sectional area larger than that of the other part of the first partition portion 216a. The same applies to the decelerating structure 273 of the second partition portion 216b. If the deceleration electrode arrangement member (in this example, the first and third partition portions 216a and 216c) has the decelerating structure 273, the decelerating structure 273 serves as a gas flow resistance. Consequently, the charged particulates P can be decelerated by the decelerating structure 273. Therefore, the charged particulates P can be further decelerated by both the deceleration electric field generated by the deceleration electrode 270 and the decelerating structure 273. In addition, since the decelerating structure 273 has a shape protruding upward and downward from the other part of the partition portion 16, the protruding part disturbs the flow of the gas, and the gas vortex can be generated downstream of the decelerating structure 273. This vortex can extend the retention time of the charged particulates P passing around the collection electrode 42, and collection of the charged particulates P by the collection electrode 42 is facilitated. In addition, unlike FIG. 9, at least one of the first and second partition portions 16a and 16b according to the above-described embodiment may have the decelerating structure 273. Furthermore, although the deceleration electrode 270 extends up to the surface of the decelerating structure 273 in the example of FIG. 9, the deceleration electrode 270 need not be located on the surface of the decelerating structure 273. Conversely, the deceleration electrode 270 may also cover the front end surface of the decelerating structure 273.

According to the embodiment described above, the second and third electric field generating electrodes 44b and 44c further function as the deceleration electrodes 70. However, the configuration is not limited thereto. A deceleration electrode may be provided separately from the electric field generating electrodes 44. In addition, according to the embodiment described above, the deceleration electric field generated by the deceleration electrode 70 decelerates the charged particulates P flowing upstream of the collection electrode 42 in the gas flow direction. However, the configuration is not limited thereto. The deceleration electric field may decelerate the charged particulates P flowing above the collection electrodes 42 (in a region immediately above the collection electrode 42 in FIG. 2). Even such a configuration can provide the effect that the collection electrode 42 easily collects the charged particulates P. For example, a deceleration electrode 370 illustrated in FIG. 10 may be employed. The deceleration electrode 370 is disposed downstream of the collection electrode 42 and the electric field generating electrode 44. The deceleration electrode 370 is a plate-like electrode disposed perpendicularly to the central axis of the gas flow channel 13 and is configured as an electrode that enables the gas and the charged particulates P to pass therethrough. More specifically, the deceleration electrode 370 is a mesh electrode having a plurality of through-holes 375 each parallel to the central axis direction of the gas flow channel 13. The gas and the charged particulates P can pass through the through-holes 375 and flow downstream. The deceleration electrode arrangement member that supports the deceleration electrode 370 is not located inside the outer wall 15, and the deceleration electrode 370 is disposed in the casing 12 in a self-supporting manner. When a voltage is applied to the deceleration electrode 370 to generate a deceleration electric field, the charged particulates P flowing above the collection electrode 42 in front of the deceleration electrode 370 (in this example, immediately above the collection electrode 42) can be decelerated. In addition, if the voltage applied to the deceleration electrode 370 is increased so that the deceleration electric field pushes back the charged particulates P that have passed beyond the collection electrode 42 in the upstream direction, the collection electrode 42 can more easily collect the charged particulates. Any through-holes that enable the gas to pass therethrough can be used as the through-holes 375. The through-holes 375 do not necessarily have to enable the charged particulates P to pass therethrough. In this case, the charged particulates P which are not collected by even the collection electrode 42 using the deceleration electric field adhere to the deceleration electrode 370. However, the deceleration electrode 370 can be periodically heated by the heater electrode 62 to incinerate the charged particulates P. In the example of FIG. 10, since the deceleration electrode 370 is located downstream of the second and third electric field generating electrodes 44b and 44c, the second and third electric field generating electrodes 44b and 44c do not have the function of an acceleration electrode.

According to the embodiment described above, the second and third electric field generating electrodes 44b and 44c further function as the acceleration electrodes 80. However, the configuration is not limited thereto. An acceleration electrode may be provided separately from the electric field generating electrode 44.

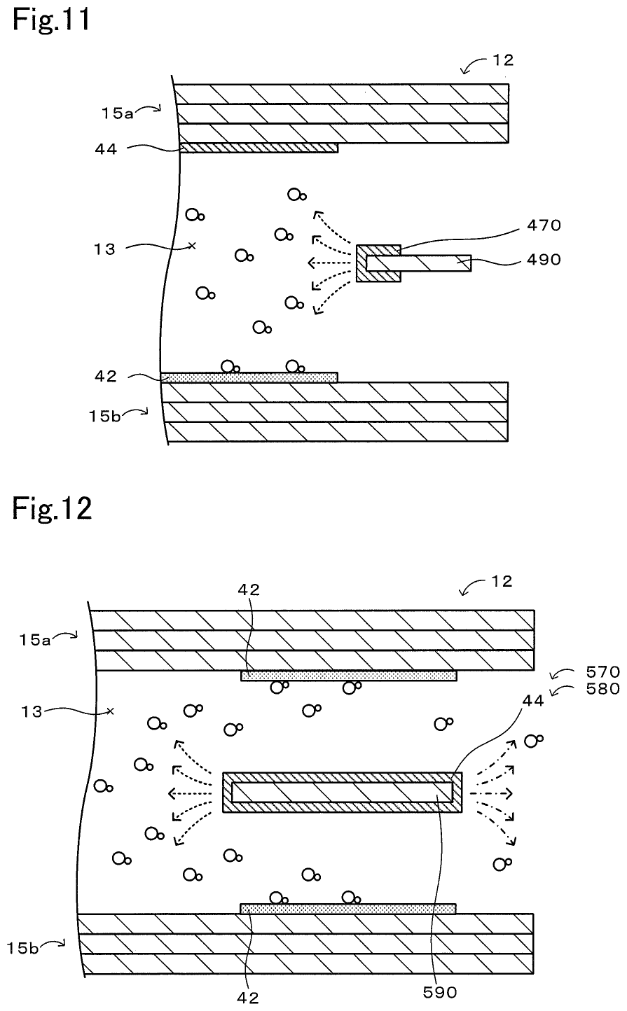

According to the embodiment described above, the partition portion 16 further functions as the deceleration electrode arrangement member and the acceleration electrode arrangement member. However, the configuration is not limited thereto. For example, as illustrated in FIG. 11, a deceleration electrode 470 may be disposed on a deceleration electrode arrangement member 490 that differs from the partition portion. In FIG. 11, the casing 12 does not have the partition portion 16, and the collection electrode 42 and the electric field generating electrode 44 are disposed on the upper surface and the lower surface of the inner peripheral surface of the outer wall 15, respectively. The deceleration electrode arrangement member 490 is a columnar member, such as a rectangular column or a circular cylinder. Since the deceleration electrode 470 is disposed on the deceleration electrode arrangement member 490 disposed such that the axial direction extends along the central axis direction of the gas flow channel 13, the deceleration electrode 470 is disposed so as to be away from the outer wall 15. The deceleration electrode 470 and the deceleration electrode arrangement member 490 are disposed downstream of the collection electrode 42. As in the example illustrated in FIG. 10, the deceleration electric field generated by the deceleration electrode 470 can decelerate the charged particulates P flowing above the collection electrode 42 (in this example, immediately above the collection electrode 42). The deceleration electrode arrangement member 490 and the deceleration electrode 470 illustrated in FIG. 11 may be provided separately from the partition portion 16 and the deceleration electrode 70 in a form including the partition portion 16 as illustrated in FIG. 2.

In the case where the casing 12 does not have the partition portion 16, the form illustrated in FIG. 12 may be adopted. In FIG. 12, the casing 12 does not include the partition portion 16, but includes a deceleration electrode arrangement member 590 disposed on the central axis of the gas flow channel 13. The deceleration electrode arrangement member 590 is a columnar member, such as a rectangular column or a circular cylinder. The electric field generating electrode 44 disposed on the deceleration electrode arrangement member 590 covers the upper and lower surfaces, the front end surface, and the rear end surface of the deceleration electrode arrangement member 590. The electric field generating electrode 44 further functions as a deceleration electrode 570 and an acceleration electrode 580. Thus, the deceleration electrode arrangement member 590 further functions as the acceleration electrode arrangement member. The collection electrodes 42 are disposed on the upper and lower surfaces of the inner peripheral surface of the outer wall 15 of the casing 12. Even in this example, the deceleration electrode 570 (in particular, the front end portion of the deceleration electrode 570 and its vicinity) generates a deceleration electric field that is directed in the upstream direction of the gas flow channel 13. Thus, the charged particulates P flowing upstream of the collection electrode 42 can be decelerated. In addition, the electric field generating electrode 44 (in particular, each of the portions of the electric field generating electrode 44 disposed on the upper and lower surfaces of the deceleration electrode arrangement member 590) generate a collection electric field that is directed in a direction perpendicular to the central axis of the gas flow channel 13 and, thus, the electric field generating electrode 44 can move the charged particulates P toward the upper collection electrode 42 and the lower collection electrode 42. Furthermore, the acceleration electrode 580 (in particular, the rear end portion of the acceleration electrode 580 and its vicinity) generates an acceleration electric field that is directed in the downstream direction of the gas flow channel 13 and, thus, the acceleration electrode 580 can accelerate the charged particulates P that are not collected by the collection electrode 42. Even when the casing 12 has the partition portion 16 as in the embodiment described above, the deceleration electrode 570 and the deceleration electrode arrangement member 590 illustrated in FIG. 12 may be further added. In addition, in FIG. 12, the deceleration electrode 570 may be disposed in the casing 12 in a self-supporting manner without the deceleration electrode arrangement member 590.

According to the embodiment described above, the deceleration electrode 70 is away from the outer wall 15. However, it is only required that at least part of the deceleration electrode 70 is away from the outer wall 15. That is, it is only required that the deceleration electrode 70 be not disposed along the inner peripheral surface of the outer wall 15 like the first electric field generating electrode 44a or be not embedded in the outer wall 15. For example, in FIG. 3, the left and right ends of the deceleration electrode 70 may extend to the outer wall 15 (in this example, left and right side walls of the outer wall 15) and be in contact with the outer wall 15. The same applies to the acceleration electrode 80.

According to the embodiment described above, the electric field generating electrode 44 is exposed to the gas flow channel 13. However, the configuration is not limited thereto. The electric field generating electrode 44 may be embedded in the casing 12. Alternatively, instead of the first electric field generating electrode 44a, a pair of electric field generating electrodes disposed so as to sandwich the first collection electrode 42a from above and below may be provided in the casing 12, and the charged particulates P may be moved toward the first collection electrode 42a by an electric field generated by a voltage applied to between the two electric field generating electrodes. The same applies to the second to fourth electric field generating electrodes 44b to 44d.

According to the embodiment described above, the collection electrode 42 and the electric field generating electrode 44 face each other in a one-to-one manner. However, the configuration is not limited thereto. For example, the number of electric field generating electrodes 44 may be smaller than that of the collection electrodes 42. For example, in FIG. 2, the second and third electric field generating electrodes 44b and 44c may be omitted, and the charged particulates P may be moved toward each of the first to third collection electrodes 42a to 42c by the electric field generated by the first electric field generating electrode 44a. If the second and third electric field generating electrodes 44b and 44c are omitted in FIG. 2, the deceleration electrode and the acceleration electrode can be provided separately. In addition, although all of the first to third electric field generating electrodes 44a to 44c move the charged particulates P downward, the configuration is not limited thereto. For example, the positions of the first collection electrode 42a and the first electric field generating electrode 44a in FIG. 2 may be reversed.

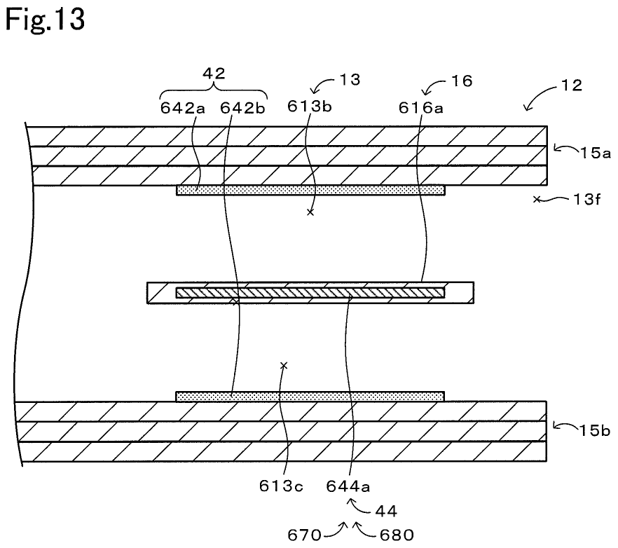

According to the embodiment described above, the configuration illustrated in FIG. 13 may be adopted. In FIG. 13, the casing 12 has a first partition portion 616a as the partition portion 16, and the gas flow channel 13 branches into two so as to have branch flow channels 613b and 613c. First and second collection electrodes 642a and 642b are disposed, as the collection electrodes 42, on the first and second outer walls 15a and 15b, respectively. The first partition portion 616a has, as the electric field generating electrode 44, a first electric field generating electrode 644a embedded therein. The first electric field generating electrode 644a further functions as a deceleration electrode 670 and an acceleration electrode 680. As illustrated in FIG. 13, even when the first electric field generating electrode 644a is embedded, the charged particulates P can be moved toward the first and second collection electrodes 642a and 642b by a collection electric field generated by the first electric field generating electrode 644a. Similarly, even when the deceleration electrode 670 is embedded, the charged particulates P can be decelerated upstream of the collection electrode 42 by the deceleration electric field generated by the deceleration electrode 670. Even when the acceleration electrode 680 is embedded, the charged particulates P that are not collected by the collection electrode 42 can be accelerated downstream of the collection electrode 42 by an acceleration electric field generated by the acceleration electrode 680. In general, the difference in thermal expansion coefficient between the electrode and an insulator (in this example, the first partition portion 616a) tends to be large. Accordingly, if, for example, a change in temperature of the casing 12 caused when the electrode is refreshed by the heater device 60 and thereafter repeatedly occurs, the thermal stress may cause the electrode to come off or fall off from the insulator. In contrast, in the example illustrated in FIG. 13, the first electric field generating electrode 644a, the deceleration electrode 670, and the acceleration electrode 680 are embedded in the first partition portion 616a. Consequently, these electrodes can be prevented from coming off or falling off, as compared with the electrodes disposed on the surface of the first partition portion 616a. As described above, at least one of the electric field generating electrode, the acceleration electrode, and the deceleration electrode may be embedded in the partition portion.

According to the embodiment described above, the first to third collection electrodes 42a to 42c are connected to a single ammeter 52. However, the configuration is not limited thereto. The first to third collection electrodes 42a to 42c may be connected to different ammeters 52. In this way, the arithmetic device 54 can separately calculate the number of particulates 17 attached to each of the first to third collection electrodes 42a to 42c. In this case, for example, by applying different voltages to the first to third electric field generating electrodes 44a to 44c or making the branch flow channels 13b to 13d have different channel thicknesses (different heights in the up-down direction in FIGS. 2 and 3), the first to third collection electrodes 42a to 42c may collect the particulates 17 having different particulate sizes.

According to the embodiment described above, the voltage V1 is applied to the first to third electric field generating electrodes 44a to 44c. However, a voltage need not be applied. Even when no electric field is generated by the electric field generating electrode 44, the charged particulates P each having a relatively small diameter and exhibiting strong Brownian motion can be caused to hit the collection electrodes 42 by setting the channel thickness of each of the branch flow channels 13b to 13d to a minute value (for example, a value greater than or equal to 0.01 mm and less than 0.2 mm). In this manner, the collection electrode 42 can collect the charged particulates P. In this case, the particulate detecting element 11 need not include the electric field generating electrode 44. When no voltage is applied to the electric field generating electrode 44 or when the electric field generating electrode 44 is not provided, the deceleration electrode and the acceleration electrode can be provided separately.

According to the embodiment described above, the deceleration electrode 70 further functions as the acceleration electrode 80. However, the configuration is not limited thereto. It is only required for the particulate detecting element 11 to include at least the deceleration electrode 70. For example, when in FIG. 2, the rear end of the deceleration electrode 70 is located upstream of the rear end of the collection electrode 42 and, thus, the electric field generated by the rear end of the deceleration electrode 70 does not act on the downstream side of the collection electrode 42, the deceleration electrode 70 does not further function as the acceleration electrode 80.

According to the embodiment described above, the deceleration electrode 70 and the acceleration electrode 80 are flat electrodes. However, the configuration is not limited thereto. In addition, the thickness of the deceleration electrode 70 may be set to 0.1 mm or less, or may be set to 0.02 mm or less. The thickness of the deceleration electrode 70 may be set to 1 μm or more, or may be set to 5 μm or more. The same applies to the thickness of the acceleration electrode 80.

According to the embodiment described above, the gas outlet 13f is located downstream of the branch flow channels 13b to 13d at a position at which the branch flow channels 13b to 13d merge. However, the configuration is not limited thereto. The gas may be discharged from the casing 12 while being separated by the branch flow channels 13b to 13d. That is, the downstream ends of the first and second partition portions 16a and 16b may be located at the same position as the downstream end of the outer wall 15 in the central axis direction of the gas flow channel 13.

According to the embodiment described above, one of the first and second charge generating devices 20a and 20b may be omitted. In addition, according to the embodiment described above, the ground electrodes 24a and 24b are embedded in the casing 12. However, if the dielectric layer is provided between the discharge electrode and the ground electrode, the ground electrode may be exposed to the gas flow channel 13. Furthermore, according to the embodiment described above, the charge generating device 20 including the discharge electrodes 21a and 21b and the ground electrodes 24a and 24b is adopted. However, the configuration is not limited thereto. For example, a charge generating device including a needle electrode and a counter electrode disposed so as to face the needle electrode with the gas flow channel 13 therebetween may be adopted. In this case, if a high voltage (for example, a DC voltage or a high frequency pulse voltage) is applied between the needle electrode and the counter electrode, an aerial discharge (in this example, a corona discharge) occurs due to the potential difference between the two electrodes. Like the embodiment described above, when the gas passes through the aerial discharge, the charges 18 are imparted to the particulates 17 in the gas and, thus, the particulates 17 turns to the charged particulates P. For example, the needle electrode may be disposed on one of the first and second outer walls 15a and 15b, and the counter electrode may be disposed on the other.

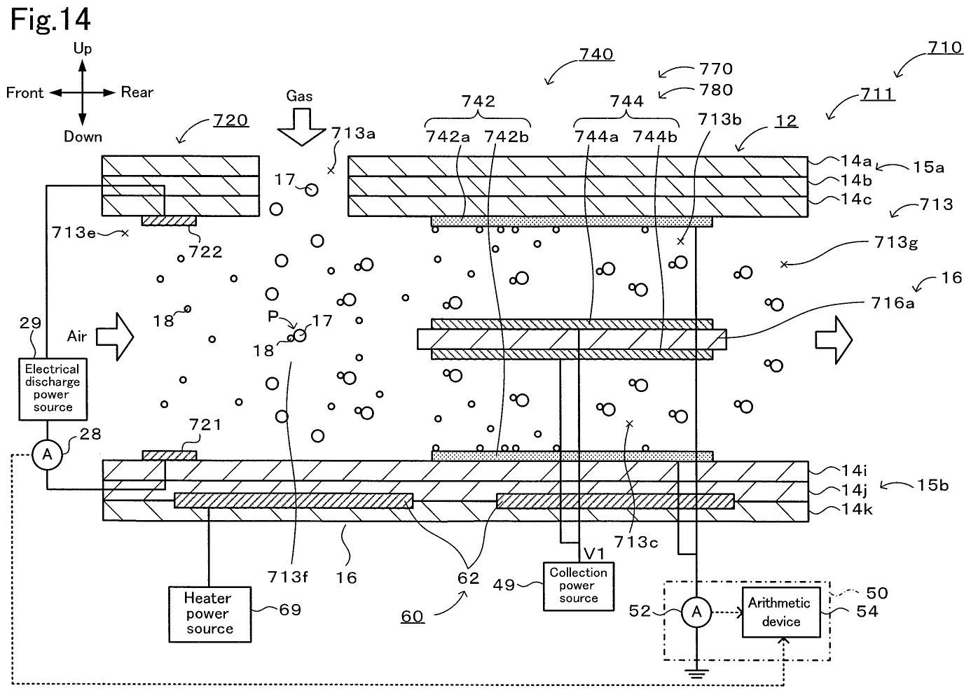

According to the embodiment described above, in the casing 12, the collection electrode 42 is provided downstream of the charge generating device 20 in the gas flow direction, and the gas containing the particulates 17 is introduced from the upstream side of the charge generating device 20 into the casing 12. The configuration is not limited thereto. In addition, according to the embodiment described above, the collection target of the collection electrode 42 is the charged particulates P. However, the collection target may be the charges 18 that are not imparted to the particulates 17. For example, the configurations of a particulate detecting element 711 and a particulate detector 710 including the particulate detecting element 711 according to a modification illustrated in FIG. 14 may be employed. The particulate detecting element 711 does not include the excess charge removal device 30 and includes a charge generating device 720, a collection device 740, and a gas flow channel 713 instead of the charge generating device 20, the collection device 40, and the gas flow channel 13, respectively. The charge generating device 720 has a discharge electrode 721 and a counter electrode 722 disposed so as to face the discharge electrode 721. The counter electrode 722 is disposed on the inner peripheral surface of the gas flow channel 713 of the casing 12, on the same side as a first collection electrode 742a (in this example, the upper side). A high voltage is applied between the discharge electrode 721 and the counter electrode 722 by the electrical discharge power source 29. The particulate detector 710 further includes an ammeter 28 that measures the electric current flowing when the electrical discharge power source 29 applies the voltage. The casing 12 of the particulate detecting element 711 has a first partition portion 716a as the partition portion 16, and the gas flow channel 713 has two branch flow channels 713b and 713c. The collection device 740 includes, as collection electrodes 742, the first collection electrode 742a disposed on the lower surface of the first outer wall 15a and a second collection electrode 742b disposed on the upper surface of the second outer wall 15b. In addition, the collection device 740 includes, as electric field generating electrodes 744, first and second electric field generating electrodes 744a and 744b respectively disposed on the upper and lower surfaces of the first partition portion 716a. Accordingly, a pair of electrodes (a pair consisting of the collection electrode 742 and the electric field generating electrode 744) is disposed in each of the branch flow channels 713b and 713c. Furthermore, two electrodes of the same type (in this example, the electric field generating electrodes 744) are disposed on the first partition portion 716a, one on the upper surface and the other on the lower surface. Each of the first and second electric field generating electrodes 744a and 744b functions as the deceleration electrode 770 and the acceleration electrode 780. The detection device 50 is connected to the collection electrode 742, and the collection power source 49 is connected to the electric field generating electrode 744. The counter electrode 722 and the collection electrode 742 may have the same potential. The gas flow channel 713 has an air inlet 713e, a gas inlet 713a, a mixing area 713f, branch flow channels 713b and 713c, and a gas outlet 713g. The air inlet 713e introduces gas not containing the particulates 17 (in this example, air) into the casing 12 via the charge generating device 20. The gas inlet 713a introduces gas containing the particulates 17 into the casing 12 such that the gas does not pass through the charge generating device 20. The mixing area 713f is provided downstream of the charge generating device 720 and upstream of the collection device 740. The air introduced through the air inlet 713e and the gas introduced through the gas inlet 713a are mixed in the mixing area 713f. The branch flow channels 713b and 713c are provided downstream of the mixing area 713f and upstream of the gas outlet 713g. The gas outlet 713g discharges the gas that has passed through the mixing area 713f and the collection device 740 to the outside of the casing 12. Note that, in the particulate detector 710, the size of the collection electrode 742 and the strength of the electric field above the collection electrode 742 (that is, the magnitude of the voltage V1) are set such that the charged particulates P are not collected by the collection electrode 742 and are discharged through the gas outlet 713g and, in addition, the charges 18 which are not imparted to the particulates 17 are collected by the collection electrode 742.

In the particulate detector 710 configured as described above in FIG. 14, if the electrical discharge power source 29 applies a voltage to between the discharge electrode 721 and the counter electrode 722 such that the discharge electrode 721 has a higher potential, an aerial discharge occurs in the vicinity of the discharge electrode 721. As a result, the charges 18 are generated in the air between the discharge electrode 721 and the counter electrode 722, and the generated charges 18 are imparted to the particulates 17 in the gas in the mixing area 713f. Therefore, even if the gas containing the particulates 17 does not pass through the charge generating device 720, the charge generating device 720 can make the particulates 17 turn into charged particulates P, like the charge generating device 20.

In addition, in the particulate detector 710 illustrated in FIG. 14, the collection electric field directed from the electric field generating electrode 744 to the collection electrode 742 is generated by the voltage V1 applied by the collection power source 49. Thus, the collection electrode 742 collects the collection target (in this example, the charges 18 which have not been imparted to the particulates 17). However, the charged particulates P are discharged through the gas outlet 713g without being collected by the collection electrode 742. In addition, the arithmetic device 54 receives, from the ammeter 52, a current value based on the charges 18 collected by the collection electrode 742 and detects the number of particulates 17 in the gas on the basis of the received current value. For example, the arithmetic device 54 derives the current difference between the current value measured by the ammeter 28 and the current value measured by the ammeter 52 and divides the derived current difference value by the elementary charge. In this manner, the arithmetic device 54 calculates the number of charges 18 (the number of passing charges) that have not been collected by the collection electrode 742 and have passed through the gas flow channel 13. Thereafter, the arithmetic device 54 divides the number of passing charges by the average value of the number of charges 18 imparted to one particulate 17 (the average charging number) to obtain the number Nt of particulates 17 in the gas. As described above, even when the collection target of the collection electrode 742 is not the charged particulates P but the charges 18 not imparted to the particulates 17, the number of particulates 17 in the gas can be detected by using the particulate detecting element 711, since the number of collection targets collected by the collection electrode 742 has a correlation with the number of particulates 17 in the gas.

Furthermore, since the first and second electric field generating electrodes 744a and 744b further function as the deceleration electrodes 770, the first and second electric field generating electrodes 744a and 744b generate the deceleration electric fields in the vicinity of the front ends thereof when the voltage V1 is applied by the collection power source 49. As a result, the collection targets (the charges 18 not imparted to the particulates 17) are decelerated by the deceleration electric field and, thus, are easily collected by the collection electrode 742. Note that the charged particulates P, which are not the collection targets, are also decelerated by the deceleration electric field. However, as compared with the charges 18 not imparted to the particulates 17, the charged particulates P have a larger particulate size. Accordingly, the amount of movement caused by the electric field is small and, thus, the charged particulates P are not easily collected by the collection electrode 742. For this reason, even if the charged particulates P are decelerated, the sizes of the collection electrode 742 and the electric field generating electrode 744 and the magnitude of the voltage V1 can be set such that the charged particulates P are not collected by the collection electrode 742 and the collection targets are collected by the collection electrode 742.

In addition, since the first and second electric field generating electrodes 744a and 744b further function as the acceleration electrodes 780, the first and second electric field generating electrodes 744a and 744b generate an acceleration electric fields in the vicinity of the rear ends thereof when the voltage V1 is applied by the collection power source 49. Thus, the charged particulates P are accelerated by the accelerating electric fields and are promptly discharged to the outside of the casing 12 through the gas outlet 713g. In the particulate detector 710, since the charged particulates P are not collection targets of the collection electrode 742, the number of the charged particulates P passing through a region downstream of the collection electrode 742 in the gas flow direction increases, as compared with the embodiment described above. For this reason, it is highly significant that the acceleration electrode 780 generates the accelerating electric field to prevent the charged particulates P from adhering to the casing 12.

In the particulate detecting element 711 illustrated in FIG. 14, the collection efficiency of the charges 18 may be predetermined in consideration of the ratio of the charges 18 not collected by the collection electrode 742 to the charges 18 not imparted to the particulates 17. In this case, the arithmetic device 54 may derive the current difference by subtracting the value obtained by dividing the current value measured by the ammeter 52 by the collection efficiency from the current value measured by the ammeter 28. Alternatively, the particulate detector 710 does not necessarily have to include the ammeter 28. In this case, for example, the arithmetic device 54 can control the voltage applied by the electrical discharge power source 29 such that a predetermined amount of charges 18 is generated per unit time, and the arithmetic device 54 can derive the current difference between a predetermined current value (the current value corresponding to the predetermined number of charges 18 generated by the charge generating device 720) and the current value measured by the ammeter 52.

According to the embodiment described above, the detection device 50 detects the number of the particulates 17 in the gas. However, the detection device 50 may detect another amount of the particulates 17 in the gas. For example, the detection device 50 may detect the amount of the particulates 17 in the gas other than the number of the particulates 17. An example of the amount of the particulates 17 is the mass or the surface area of the particulates 17 other than the number of the particulates 17. For example, when the detection device 50 detects the mass of the particulates 17 in the gas, the arithmetic device 54 may further multiply the number Nt of the particulates 17 by the mass per particulate 17 (for example, the average value of mass). In this manner, the detection device 50 may detect the mass of the particulates 17 in the gas. Alternatively, the arithmetic device 54 may store the relationship between the accumulated charge amount and the total mass of the collected charged particulates P in the form of a map in advance, and the arithmetic device 54 may directly derive the mass of the particulates 17 in the gas from the accumulated charge amount by using the map. Even in the case where the arithmetic device 54 obtains the surface area of the particulates 17 in the gas, the same method as in the case of calculating the mass of the particulates 17 in the gas can be used. Note that even in the case where the collection target of the collection electrode 42 is the charges 18 that have not been imparted to the particulates 17, the detection device 50 can detect the mass or the surface area of the particulates 17 in the same manner as described above.

According to the embodiment described above, the case of measuring the number of positively charged particulates P is described. However, even negatively charged particulates P can be decelerated or accelerated in the same manner. In addition, the number of the negatively charged particulates 17 can be measured in the same manner.

This application claims the benefit of Japanese Patent Application No. 2017-45632 filed Mar. 10, 2017 and No. 2017-45633 filed Mar. 10, 2017, which are hereby incorporated by reference herein in their entirety.

What is claimed is:

1. A particulate detecting element for detecting particulates in gas, comprising:
a casing having a gas flow channel that enables the gas to pass therethrough;
a charge generating unit configured to impart charges generated by electric discharge to the particulates in the gas introduced into the casing and turn the particulates into charged particulates;
a collection electrode disposed in the casing, the collection electrode collecting a collection target representing one of the charged particulate and the charge not imparted to the particulate; and
a deceleration electrode disposed such that at least part of the deceleration electrode is away from an outer wall of the gas flow channel in the casing, the deceleration electrode generating a deceleration electric field that decelerates the collection target at least one of upstream of the collection electrode in a gas flow direction and above the collection electrode.

2. The particulate detecting element according to claim 1,
wherein the casing includes a partition portion configured to partition off the gas flow channel into a plurality of branch flow channels, and
wherein the collection electrode is disposed in each of the plurality of branch flow channels.

3. The particulate detecting element according to claim 2, further comprising:
at least one electric field generating electrode configured to generate a collection electric field for moving the collection target toward the collection electrode disposed in at least one of the branch flow channels.

4. The particulate detecting element according to claim 3, further comprising:
a plurality of pairs each consisting of the collection electrode and the electric field generating electrode, and each of the branch flow channels has one of the pairs disposed therein.

5. The particulate detecting element according to claim 3,
wherein at least one of the electric field generating electrodes further functions as the deceleration electrode.

6. The particulate detecting element according to claim 1,
wherein the casing includes a deceleration electrode arrangement member on which the deceleration electrode is to be disposed, and
the deceleration electrode arrangement member is disposed on the inner side of the outer wall.

7. The particulate detecting element according to claim 6,
wherein a distance Lf, in a central axis direction of the gas flow channel, between an upstream end of the deceleration electrode arrangement member in the gas flow direction and the deceleration electrode is less than or equal to a distance H, in a direction perpendicular to the central axis of the gas flow channel, between the deceleration electrode arrangement member and a wall portion of the casing.

8. The particulate detecting element according to claim 6,
wherein the deceleration electrode is disposed on an upstream end surface of the deceleration electrode arrangement member in the gas flow direction.

9. The particulate detecting element according to claim 6,
wherein the deceleration electrode arrangement member has, at the upstream end thereof in the gas flow direction, a decelerating structure having a shape with a cross-sectional area larger than that of the other portion as viewed in a cross section perpendicular to the central axis of the gas flow channel.

10. A particulate detector comprising:
the particulate detecting element according to claim 1; and
a detection unit configured to detect the particulates on the basis of a physical quantity that changes in accordance with collection targets collected by the collection electrode.
